(19) United States
(12) Patent Application Publication
(10) Pub. No.: US 2003/0098221 A1
(43) Pub. Date: May 29, 2003

(54) Method and apparatus for preventing the activation of an electrical component

(76) Inventors: Jasdeep Bhusri, Plainville, CT (US); Dhirendra K. Tiwari, Hyderabad, IN (US)

Correspondence Address: PATENT OPERATION, GENERAL ELECTRIC COMPANY, 41 WOODFORD AVENUE, PLAINVILLE, CT, 06062

(21) Appl. No.: 09/683,182

(22) Filed: Nov. 29, 2001

(51) Int. Cl. H01H 9/28

(52) U.S. Cl. 200/43.01; 307/326

(57) ABSTRACT

A method and apparatus for preventing the activation of an electrical component within an electrical distribution network. The apparatus comprises an electrical component, such as a disconnect switch, a means for the actuation thereof, and an independently moving restriction means. When the electrical component is in a deactivated condition, the actuation and restriction members are capable of being coupled together with a locking device, such as a padlock, to prevent activation of the electrical component. Conversely, when the electrical component is in an activated condition, the actuation member may moved to deactivate the electrical component, regardless of the installation of one or more locking devices in the two members. Hence, the electronic component may not be restricted to the activated condition.

### BACKGROUND OF INVENTION

In order to provide electric power to various appliances found in typical residential or industrial buildings, electrical networks of varying complexity are utilized. Such networks generally include electricity conductors, such as wires and electrical busway, and devices having functionality that is more complex. The former typically have some degree of physical protection, such as a protective conduit sheath or a rigid metallic housing. The more complex devices are employed to perform a number of different functions. Transforming devices, such as transformers, capacitor, and inductors, typically comprise inductive and capacitive devices. These devices change the waveform characteristics of the electrical current passing therethrough. Power control devices, such as switches and switchgear, as well as protection devices, such as circuit breakers and fuses, alter the connections, the configuration, and the electrical current within the electrical network depending upon the required power conditions. These devices include an electrical conductor for each current path; a subsection of the conductor is moveable relative to the remaining sections of conductor. This allows the device to open and close a circuit when necessary. Monitoring and metering devices, which can include automated systems and sensing devices, collect and analyze performance data representative of the characteristics of the electrical network. Typically, such devices are composed of current transducers, an electronic measuring device connected to the transducers, and a memory bank to record the power metrics over time. Communication devices such as computers and their associated network devices can also be used in conjunction with the monitoring and metering devices to transmit the data to remote locations. Communication devices are sometimes installed inside electronic appliances; such devices serve as a communication link between sensors in appliances and remote devices that can manipulate and store the resulting data. To safeguard the electrical network against interruptions in the external power supply, power storage and generation devices, such as battery banks, generators, and uninterruptible power supplies, are sometimes installed within the network. The end point devices of the network are the primary recipients of the power transmitted over the network. In broad terms, such devices convert electrical energy into more useful media, such as rotational or thermal energy. End point devices typically contain conductor coils for heating, illumination, or magnetism, or electronic components for more precise operations. These devices include electric motors, manufacturing machinery, heating, ventilating, and air conditioning devices, and lighting appliances.

In order to house various types of electrical components, the electrical utility industry utilizes enclosures, such as upright pedestals, cabinets and terminal boxes. The particular enclosure depends largely upon the type of electrical component to be housed and its place of installation. Typically, the enclosed component can be controlled by an actuator external to the enclosure, such as a push button, knob, or lever. In some instances, multiple electrical components are housed in a single enclosure. The actuator for one such device may or may not interact with other devices installed within the same enclosure.

To protect the enclosed electrical components from unauthorized activation, and the downstream circuitry from unauthorized use, the electric utility industry utilizes certain control devices, specifically those capable of disconnecting end devices from the power source, and their respective actuators to be lockable in a deactivated position. In the deactivated, or “off” condition, electric current is prohibited from passing through the electrical component, thus affecting the state of the electrical end point loads located downstream. Conversely, in the activated, or “on” condition, electric current is allowed to pass through the component, thus affecting the end point loads in a different manner. Such lockout systems typically provide for the installation of separate locking devices, such as padlocks, externally to the enclosure to restrict access to the electrical component.

An electrical component is usually moved between “on” and “off” positions using a rotational lever, the pivoting axis of which typically passes through the side of the enclosure such that the lever arm is entirely outside the enclosure. To activate and deactivate the component properly, the lever must be fully displaced to the end of its allowed path of travel. In order to prevent the unauthorized activation of the component by means of the lever, a lockout is provided to restrict the lever to the “off” position. The lockout usually comprises a rigid metal sheet positioned in a plane approximately parallel to the rotary path of the lever. In the material forming the lever and sheet are placed an approximately identical series of holes such that in the “off” position, corresponding holes in the handle and the sheet overlap. Such configuration permits the shackle of a padlock to pass through a pair of corresponding holes in the lever and the sheet, rendering the lever essentially immobile.

It is therefore considered advantageous to allow the locking of said actuator in the “off” position only.

### SUMMARY OF INVENTION

In one aspect, a lockout system is provided which comprises an actuation member having at least one opening along its length. The actuation member is coupled to the activation means of an electrical component. The actuation member interacts with a restriction member, also having at least one opening along its length. The two members are capable of being coupled together with a locking device such that the electrical component may not be activated. However, when in the activated position, the actuation member may deactivate the electrical component regardless of the presence of a locking device in any of the holes.

### BRIEF DESCRIPTION OF DRAWINGS

The invention will now be described in greater detail, by way of example, with reference to the drawings as follows.

FIG. 1 is a representation of an electrical power distribution and control system.

FIG. 2 is a front view of an electrical component enclosure and lockout system connected to a section of busway and an electrical wire conduit.

FIG. 3 is a perspective view of the electrical appliance locked in the “off” position.

FIG. 4 is a side view of a locking system of the type having rotational actuation and restriction members. The system locks the electrical component in the “off” position.

FIG. 5 is a side view of the locking system of the type having rotational actuation and translation members. The unlocked system allows the electrical component to reach the “on” position.

FIG. 6 is a side view of a locking system of the type having a rotational actuation member and a translational restriction member. The electrical component is locked in the “off” position.

FIG. 7 is a side view of a locking system of the type having a rotational actuation member and a translational restriction member. The electrical component is in the “on” position.

FIG. 8 is a side view of a locking system of the type having translational actuation and restriction members. The electrical component is locked in the off position.

FIG. 9 is a side view of a locking system of the type having translational actuation and restriction members. The electrical component is in the “on” position.

FIG. 10 is a side view of a locking system of the type having a rotational actuation member and a flexible restriction member. The electrical component is locked in the “off” position.

FIG. 11 is a side view of a locking system of the type having a rotational actuation member and a flexible restriction member. The electrical component can be activated when the locking device is removed.

### DETAILED DESCRIPTION

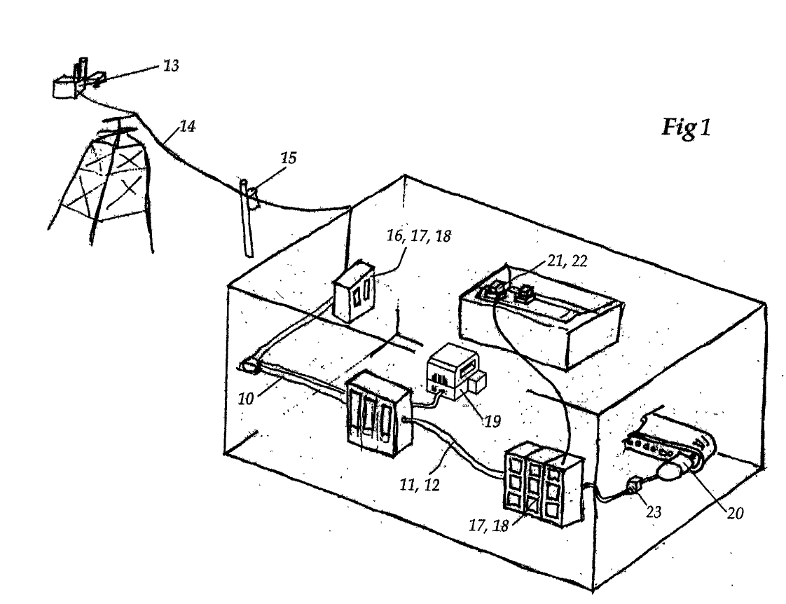

FIG. 1 is a representation of an electrical network composed of several types of devices. Electric power is generated by a utility 13 and transported by transmission lines 14. A transforming device 15 is shown mounted on a utility pole, although similar devices may also be found inside buildings. Typically, a metering device 16, a control device 17, and a protection device 18 are the first devices incoming electric current passes through after leaving the utility lines 14. In larger buildings where electric power continuity is critical, the network may also include a device such as a generator or power storage device 19 to sustain the network current in the event external power is lost. The circuits formed by the electrical conductors multiply and branch outward to the end point loads 20. End point loads are simply devices that consume the electrical power transmitted via the network. Each smaller circuit contains control 17 and protection 18 devices in addition to the larger devices upstream. Metering devices 16 generally quantify the amount of power consumed by the power network in which they are installed. Monitoring 21 and communication 22 devices are often employed to analyze the characteristics of the electric energy remotely using sensors connected to various points in the network. Typically, immediately prior to entering an end point load 20, the electric current passes through an electrical appliance 23. For example, a disconnect switch provides a means of quick disconnection of the load 20 from the power supply 13.

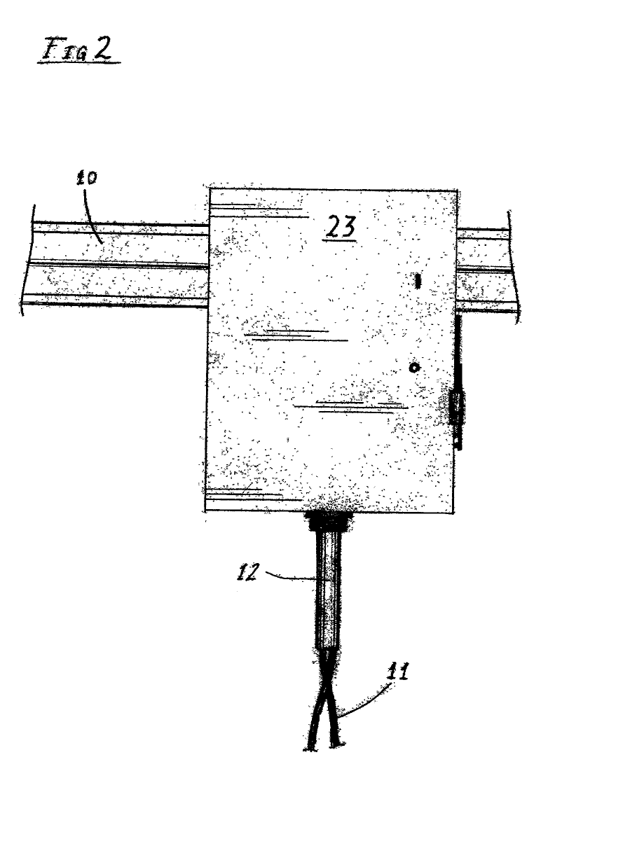

In order to bring electricity into and out of the electrical appliance 23, conductors such as cables or busway are used. FIG. 2 shows an enclosure and described lockout system used in conjunction with both a section of busway 10 and electrical wires 11 housed in conduit 12. Such articles enable electrical current to be transmitted between devices within the network by providing conductors and protection therefore.

An electrical component 26 mounted within an enclosure 24 shall be dubbed an electrical appliance 23 henceforth. An electrical component could be a disconnect switch, a circuit breaker, a communication device, a computer device, a data communication or recording device, a sensing device or monitoring device, an energy storage device, a control device, or any similar device having electric or electronic functionality. The electrical appliance 23 is one part of a larger electrical network of several devices.

Referring to FIGS. 3, 4, and 5, a lockout system for an electrical appliance 23 first includes a rotational actuator 25 capable of moving the electrical component 26 between “on” and “off” positions. The actuator 25 is typically a physical extension of the electrical component control to allow easy operation. A restrictor 27 is fixed to the enclosure proper 24 by means of a pivot 28 to allow free rotation of the restrictor about an axis approximately parallel to the lever axis 29. In the embodiment illustrated in FIGS. 3, 4, and 5, the electrical appliance is an electrical disconnect switch, and the actuator and restrictor consist of a rotating lever 25 and rotating arm 27, respectively. An approximately identical pattern of holes 30, 31 is placed in both the actuator and restrictor.

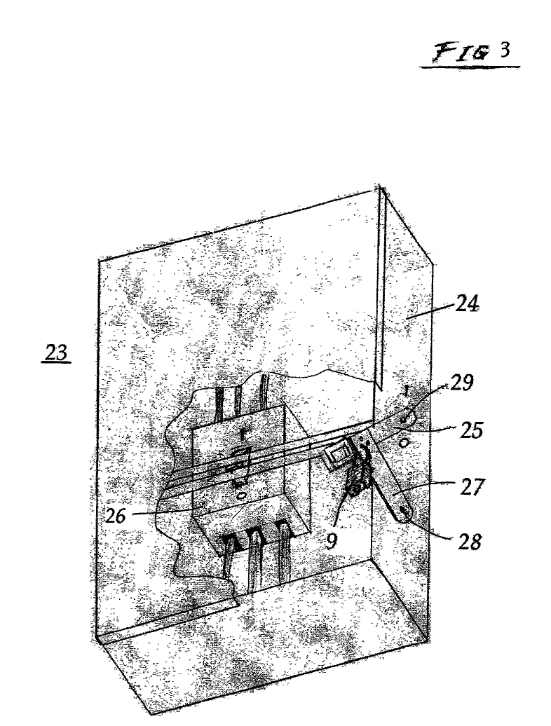

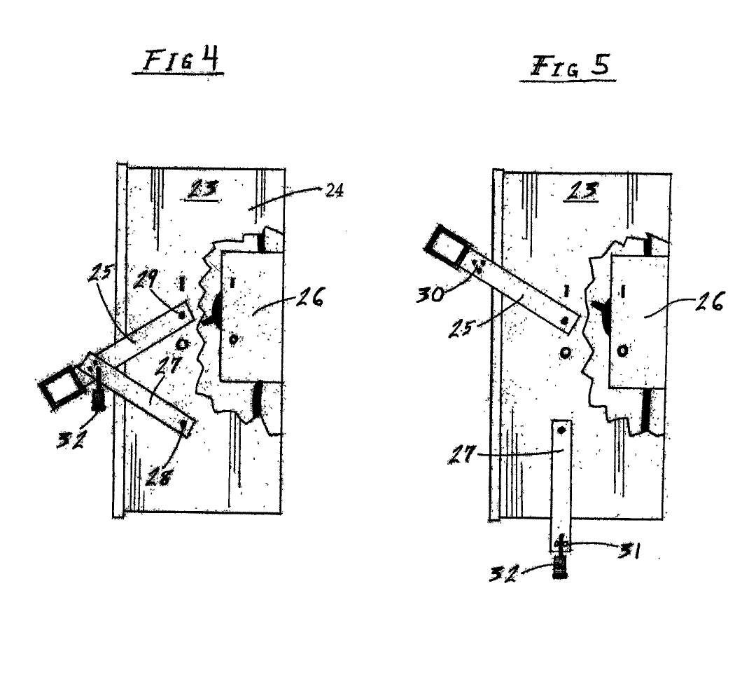

As shown in FIGS. 3 and 4, when in the “off” position, usually indicated by a symbol such as “O”, the pattern of holes on each the lever 25 and arm 27 are able to align overlappingly. That is, the profiles of the holes on each member can concurrently receive a locking device 32 such as a padlock. The installation of a locking device fixes the lever 25 and arm 27 together, restricting their motion with respect to one another. FIG. 5 shows the configuration of the members when the electrical component 26 is in the activated position. The restrictor 27 is capable of rotation out of the path of said actuator 25. Hence, if when in the “on” position, usually indicated by a symbol such as “I”, a locking device 32, such as a padlock, is installed by placing its shackle through any of the holes 30, 31 in either the lever or the arm, the lever 25 is not prevented from moving to the “off” position.

As shown in FIGS. 4 and 5, the lockout system is illustrated on an electrical appliance 23 installed as is typical for such a device. Usually, devices are mounted vertically, such that their length is generally perpendicular to the floor. In this orientation, the “off” position is usually reached by displacing the actuating lever downward. Since the locking arm 27 is free to rotate about its pivot 28, unless it is fixed to the actuating lever 25 as shown in FIG. 4, the arm will rotate downward. Gravitational force biases the arm to move out of the path of the actuating lever. The locking arm 27 thus cannot impede the motion of the actuating lever 25. The locking arm may also be biased by springs or other means that can exert a force upon the member.

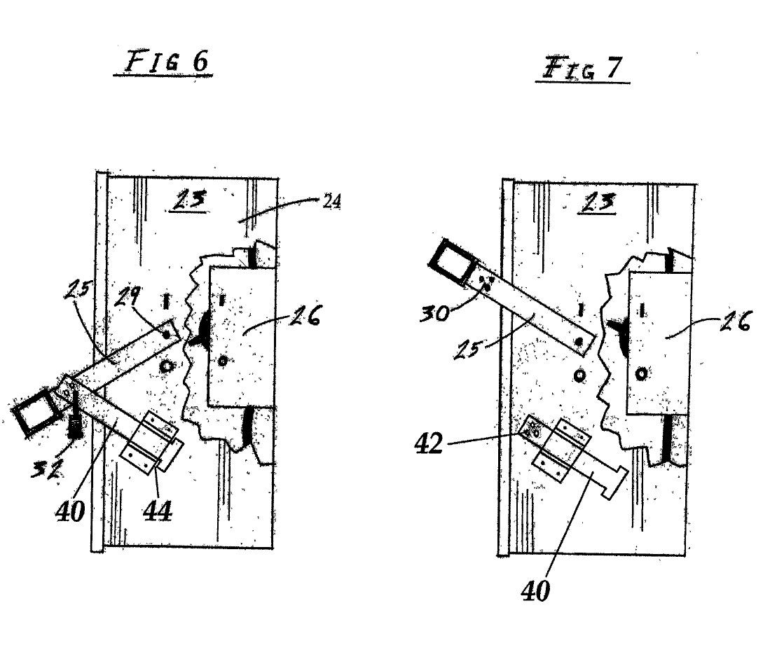

FIGS. 6 and 7 show an alternate embodiment of the invention, wherein the lockout system includes a rotational lever 25 capable of actuating the electrical component 26 and a translationally moving restriction bar 40. Each of these two components include at least one opening 30,42 along its length capable of receiving a locking device 32, such as a padlock, therethrough. The sliding restriction bar 40 is capable of extending toward the actuation lever 25 when the latter is in the “off” position such that the openings on both members are aligned. Once the two parts are aligned properly, further extension of the restriction bar 40 is prohibited by a positive stop 44. Hence, when the two components are coupled together with a locking device 32, the actuation lever cannot move the electrical component 26 to the “on” position. However, when in the “on” position, the sliding restriction bar 40 is not capable of impeding the motion of the actuation lever 25. As it moves toward the “off” position, the latter pushes the former out of the way, causing the bar to retract.

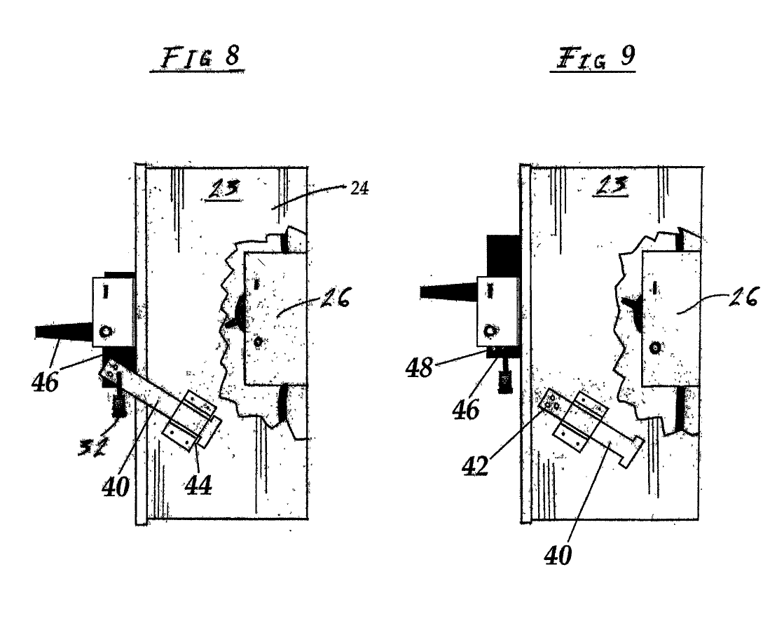

Other embodiments of the lockout system are possible using combinations of translational and rotational members. The actuation member is a translating slide 46 wherein the “on” and “off” positions correspond to opposite ends of its path of travel. The restriction member is therefore either a rotational arm 27 or a translating bar 40 as described previously. FIGS. 8 and 9 depict a lockout system having the latter. In each member, there are corresponding openings 48,42 for at least one locking device 32 so the two may be coupled together. Due to the presence of a locking device, these elements can exert a force upon the actuation member 25 only in the direction of travel necessary for activation of the electrical component 26.

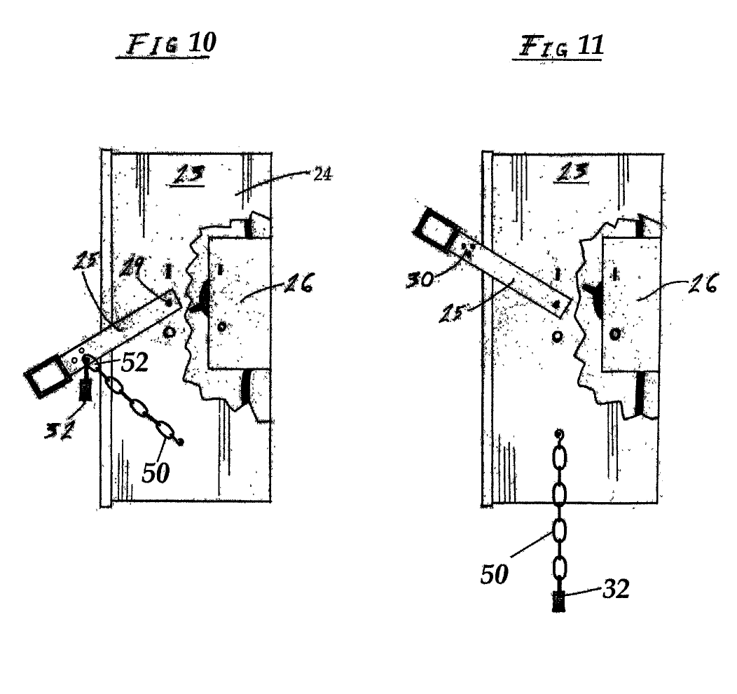

FIGS. 10 and 11 illustrate a further embodiment of the invention utilizing a rigid translational 46 or rotational 25 actuation member, and a non-rigid restriction member 50. This type of restriction member is flexible but non-elastic, such as a cable or chain. Thus, the flexible restriction member 50 is coupled to the actuation member such that attempting to actuate the latter toward the “on” position subjects the former to a tensile force. Since the flexible restriction member is not elastic, the motion of the actuation member is restrained. However, since the former easily buckles under a compressive force, when a locking device 32 is placed into any opening 30,52 in either the actuation 25 or restriction 50 members when the former is in the “on” position, the actuation member can always be moved to the “off” position.

An appliance with the described lockout system is commonly mounted on a wall in a vertical orientation. When not coupled to the actuation lever, the restriction members of the described designs translate downward due to gravitational force. Since they are thus biased away from the path of the actuation member, the restriction members cannot impede the motion of the actuation member in any way regardless of the presence or number of locking devices installed therethrough.

The present invention described heretofore refers to the accompanying drawings, in which a preferred embodiment of the invention is shown. This invention may, however, be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout.

What is claimed is:

1. A lockout system for restricting the activation of an electrical component said lockout system comprising:
at least one electrical component;
an actuation member coupled to said at least one electrical component, said actuation member having at least one opening along its length;
at least one locking device;
a restriction member having at least one opening along its length, said restriction member interacting with said actuation member such that said openings on said actuation member and said restriction member are overlapping and said restriction member also moveable such that while said at least one locking device is engaged in any one of said openings, said electrical component can be deactivated.

2. A lockout system in accordance with claim 1 wherein said electrical component is housed within an enclosure.

3. A lockout system in accordance with claim 2 wherein at least one of said actuation member and said restriction member is coupled to said enclosure.

4. A lockout system in accordance with claim 1, further comprising at least one of an electrical conduit, an electrical wire, and an electrical bus enabling the conduction of electrical current through said electrical component.

5. A lockout system in accordance with claim 1, further comprising at least one of a power control device, a protection device, and a transforming device electrically coupled to said electrical component such that electrical current passing through said component may be altered by said device.

6. A lockout system in accordance with claim 1, further comprising at least one of a monitoring device, a metering device, and a communication device coupled to said electrical component such that analysis of the current passing through said electrical component may be performed.

7. A lockout system in accordance with claim 1, further comprising an interruption safeguard device electrically coupled to said electrical component such that current passing through said electrical component may be sustained during a loss of external electrical current.

8. A lockout system in accordance with claim 1, further comprising at least one end point device electrically coupled to said electrical component such that current passing through said electrical component is consumed by said device.

9. A lockout system in accordance with claim 1 wherein, said restriction member is biased to allow motion of said actuation member.

10. A lockout system in accordance with claim 1, further comprising at least one electrical component mounted within said enclosure in addition to said electrical component protected by said lockout system.

11. A method for restricting the activation of an electrical component, said method comprising:
moving a member capable of actuating at least one electrical component, said member having at least one opening therethrough;
moving a member capable of restricting the motion of said actuation member, said restricting member having at least one opening therethrough;
installing at least one locking device through at least one opening on each of said actuating member and said restricting member.

12. A method in accordance with claim 11 wherein the step of moving said actuating member includes the step of actuating at least one electrical component within an enclosure.

13. A method in accordance with claim 12 wherein the step of moving said actuation member includes moving an actuation member connected to said enclosure.

14. A method in accordance with claim 12 wherein the step of moving said restriction member includes moving a restriction member connected to said enclosure.

15. A method in accordance with claim 11 wherein the step of moving the actuating member includes actuating at least one electrical component, the conduction of electrical current through said electrical component being enabled by at least one of an electrical conduit, an electrical wire, and an electrical bus.

16. A method in accordance with claim 11 wherein the step of moving the actuating member includes actuating at least one electrical component, thus altering the electrical current passing through at least one of a control device, a protection device, a transforming device, a monitoring device, a metering device, a communication device, an interruption safeguard device, and an end point device.

17. A method in accordance with claim 11 wherein the step of moving the restriction member further comprises moving a restriction member biased to allow unimpeded motion of the actuation member to the deactivated position.

18. A lockout system for an electrical component comprising:
means for actuating at least one electrical component, said means including at least one opening passing therethrough;
means for restricting the motion of said actuating means wherein said restricting means is moveable and wherein said restricting means has at least one opening passing therethrough;
means for constraining at least one opening on each of said actuating and said restricting means to be overlapping such that said actuating means and said electrical component are essentially immobile relative to one another such that said electrical component is constrained in a deactivated position.

19. A lockout system in accordance with claim 18 wherein at least one of said actuating means and said restricting means are connected to an enclosure in which said electrical component is housed.

20. A lockout system in accordance with claim 18, further comprising means for enabling the conduction of electrical current through said electrical component.

21. A lockout system in accordance with claim 18, further comprising means for altering the electrical current passing through said electrical component.

22. A lockout system in accordance with claim 18, further comprising means for analyzing the electrical current passing through said electrical component.

23. A lockout system in accordance with claim 18, further comprising means for sustaining electrical current through said electrical component during a loss of external electrical current.

24. A lockout system in accordance with claim 18, further comprising means for consuming the electrical current passing through said electrical component.

25. A lockout system for an enclosure housing at least one electrical disconnect devices, said lockout system comprising:
at least one electrical disconnect device;
an enclosure, said at least one electrical disconnect device located within said enclosure;
an actuation lever coupled to said at least one electrical disconnect device, said lever having at least one opening along its length;
at least one locking device;
a restriction arm having at least one opening along its length, said arm interacting with said lever such that said openings on each of said lever and said arm are approximately overlapping and said arm also moveable such that the while said at least one locking device is engaged in any of said openings, the electrical disconnect device can be deactivated.

26. A lockout system for an enclosure housing at least one electrical disconnect devices, said lockout system comprising:
at least one electrical disconnect device;
an enclosure, said at least one electrical disconnect device located within said enclosure;
an actuation lever coupled to said at least one electrical disconnect device, said lever having at least one opening along its length;
at least one locking device;
a restriction bar having at least one opening along its length, said arm interacting with said lever such that said openings on each of said lever and said bar are approximately overlapping and said bar also moveable such that while said at least one locking device is engaged in any of said openings, the electrical disconnect device can be deactivated.

27. A lockout system for an enclosure housing at least one electrical disconnect devices, said lockout system comprising:
at least one electrical disconnect device;
an enclosure, said at least one electrical disconnect device located within said enclosure;
an actuation slide coupled to said at least one electrical disconnect device, said slide having at least one opening along its length;
at least one locking device;
a restriction bar having at least one opening along its length, said bar interacting with said slide such that said openings on each of said slide and said bar are approximately overlapping and said bar also moveable such that the while said at least one locking device is engaged in any of said openings, the electrical disconnect device can be deactivated.

28. A lockout system for an enclosure housing at least one electrical disconnect devices, said lockout system comprising:
at least one electrical disconnect device;
an enclosure, said at least one electrical disconnect device located within said enclosure;
an actuation lever coupled to said at least one electrical disconnect device, said lever having at least one opening along its length;
at least one locking device;
a flexible, non-elastic restriction member having at least one opening along its length, said restriction member interacting with said lever such that said openings on each of said lever and said restriction member are approximately overlapping and said restriction member also moveable such that the while said at least one locking device is engaged in any of said openings, the electrical disconnect device can be deactivated.

29. A lockout system in accordance with claim 25 wherein at least one of said actuation lever and said restriction arm is coupled to said enclosure.

30. A lockout system in accordance with claim 26 wherein at least one of said actuation lever and said restriction bar is coupled to said enclosure.

31. A lockout system in accordance with claim 27 wherein at least one of said actuation slide and said restriction bar is coupled to said enclosure.

32. A lockout system in accordance with claim 28 wherein at least one of said actuation lever and said restriction member is coupled to said enclosure.

33. A lockout system in accordance with claim 25 wherein, said restriction arm is biased to allow unimpeded motion of said lever.

34. A lockout system in accordance with claim 26 wherein, said restriction bar is biased to allow unimpeded motion of said lever.

35. A lockout system in accordance with claim 27 wherein, said restriction bar is biased to allow unimpeded motion of said lever.

36. A lockout system in accordance with claim 28 wherein, said restriction member is biased to allow unimpeded motion of said lever.

37. A lockout system in accordance with claim 25, further comprising at least one of an electrical conduit, an electrical wire, and an electrical bus enabling the conduction of electrical current through said electrical disconnect device.

38. A lockout system in accordance with claim 26, further comprising at least one of an electrical conduit, an electrical wire, and an electrical bus enabling the conduction of electrical current through said electrical disconnect device.

39. A lockout system in accordance with claim 27, further comprising at least one of an electrical conduit, an electrical wire, and an electrical bus enabling the conduction of electrical current through said electrical disconnect device.

40. A lockout system in accordance with claim 28, further comprising at least one of an electrical conduit, an electrical wire, and an electrical bus enabling the conduction of electrical current through said electrical disconnect device.

41. A lockout system in accordance with claim 25, further comprising at least one of a power control device, a protection device, and a transforming device electrically coupled to said electrical disconnect device such that electrical current passing through said electrical disconnect device may be altered by said device.

42. A lockout system in accordance with claim 26, further comprising at least one of a power control device, a protection device, and a transforming device electrically coupled to said electrical disconnect device such that electrical current passing through said electrical disconnect device may be altered by said device.

43. A lockout system in accordance with claim 27, further comprising at least one of a power control device, a protection device, and a transforming device electrically coupled to said electrical disconnect device such that electrical current passing through said electrical disconnect device may be altered by said device.

44. A lockout system in accordance with claim 28, further comprising at least one of a power control device, a protection device, and a transforming device electrically coupled to said electrical disconnect device such that electrical current passing through said electrical disconnect device may be altered by said device.

45. A lockout system in accordance with claim 25, further comprising at least one of a monitoring device, a metering device, a communication device coupled to said electrical disconnect device such that analysis of the current passing through said disconnect device may be performed.

46. A lockout system in accordance with claim 26, further comprising at least one of a monitoring device, a metering device, a communication device coupled to said electrical disconnect device such that analysis of the current passing through said disconnect device may be performed.

47. A lockout system in accordance with claim 27, further comprising at least one of a monitoring device, a metering device, a communication device coupled to said electrical disconnect device such that analysis of the current passing through said disconnect device may be performed.

48. A lockout system in accordance with claim 28, further comprising at least one of a monitoring device, a metering device, a communication device coupled to said electrical disconnect device such that analysis of the current passing through said disconnect device may be performed.

49. A lockout system in accordance with claim 25, further comprising an interruption safeguard device electrically coupled to said electrical disconnect device such that current passing through said electrical disconnect device may be sustained during a loss of external electrical current.

50. A lockout system in accordance with claim 26, further comprising an interruption safeguard device electrically coupled to said electrical disconnect device such that current passing through said electrical disconnect device may be sustained during a loss of external electrical current.

51. A lockout system in accordance with claim 27, further comprising an interruption safeguard device electrically coupled to said electrical disconnect device such that current passing through said electrical disconnect device may be sustained during a loss of external electrical current.

52. A lockout system in accordance with claim 28, further comprising an interruption safeguard device electrically coupled to said electrical disconnect device such that current passing through said electrical disconnect device may be sustained during a loss of external electrical current.

53. A lockout system in accordance with claim 25, further comprising at least one end point device electrically coupled to said electrical disconnect device such that current passing through said electrical disconnect device is consumed by said end point device.

54. A lockout system in accordance with claim 26, further comprising at least one end point device electrically coupled to said electrical disconnect device such that current passing through said electrical disconnect device is consumed by said end point device.

55. A lockout system in accordance with claim 27, further comprising at least one end point device electrically coupled to said electrical disconnect device such that current passing through said electrical disconnect device is consumed by said end point device.

56. A lockout system in accordance with claim 28, further comprising at least one end point device electrically coupled to said electrical disconnect device such that current passing through said electrical disconnect device is consumed by said end point device.

57. A lockout system in accordance with claim 25, further comprising at least one electrical disconnect device mounted within the enclosure in addition to the electrical disconnect device protected by the lockout system.

58. A lockout system in accordance with claim 26, further comprising at least one electrical disconnect device mounted within the enclosure in addition to the electrical disconnect device protected by the lockout system.

59. A lockout system in accordance with claim 27, further comprising at least one electrical disconnect device mounted within the enclosure in addition to the electrical disconnect device protected by the lockout system.

60. A lockout system in accordance with claim 28, further comprising at least one electrical disconnect device mounted within the enclosure in addition to the electrical disconnect device protected by the lockout system.
